(19) United States
(12) Patent Application Publication
(10) Pub. No.: US 2014/0297443 A1
(43) Pub. Date: Oct. 2, 2014

(54) Method of bidding to qualify and win a meeting in an on-line auction

(71) Applicant: Staecy Carpenter, San Jose, CA (US)

(72) Inventor: Staecy Carpenter, San Jose, CA (US)

(21) Appl. No.: 13/854,097

(22) Filed: Mar. 31, 2013

(51) Int. Cl. G06Q 30/08

(52) U.S. Cl. CPC G06Q 30/08
USPC 705/26.3

(57) ABSTRACT

Method of bidding in an on-line auction to qualify and satisfy requirements for winning meeting time with a person, either in-person or through an interactive on-line communications network such as the Internet. The method includes the bidder uploading a document or data on-line with information relative and in response to the stated meeting requirements or criteria of meeting host when placing a bid, acceptance of meeting bids based on the information submitted, not accepting meeting bids based on the highest bid amount, accepting one or multiple bids and scheduling one or multiple meetings in a single meeting auction.

I claim priority of provisional patent application 61/619,829 filed on Apr. 3, 2012.

### FIELD OF THE INVENTION

The invention relates generally to conducting on-line meeting auctions, and in particular, using a document or data that is submitted on-line with information for satisfying meeting requirements to qualify bidders and win meetings.

### BACKGROUND OF THE INVENTION

Meaningful business relationships often begin after a first meeting, which may occur by videoconference, an on-line meeting or, in the best case scenario, meeting in person. Meaningful meetings can be defined as time well spent; a person's time is very valuable and can be easily wasted if the parties involved in the meeting have not properly communicated the goals and purpose of the meeting beforehand. To help ensure meetings are productive and effective, an agenda can provide a clear understanding of expectations for all parties involved prior to the meeting. Traditionally, when a business introduction is facilitated between two parties (i.e. buyers and sellers), an agenda is prepared, presented and reviewed to confirm expectations before the meeting begins. An agenda generally states what is to be accomplished in the meeting with names and titles of those attending. Depending on the reason for the meeting, a proposal may be presented. Therefore, when bidding on a meeting in an on-line meeting auction, a way to qualify the meeting is to present an agenda or proposal to ensure the meeting is productive and effective before the meeting is accepted.

Auction Process:

Meetings that are auctioned on-line are conducted either in-person or on-line, they are auctioned to the public for bid. Parties that bid on meetings are required to submit a document or data, in most cases a proposed meeting agenda or proposal, when placing a bid. The meeting host (person who advertises on-line their meeting availability and criteria) will accept or decline bids on-line based on the information provided in the document or data submitted.

A meeting host registers on-line to add a meeting for auction. A person places a bid by completing the Place Bid form, which includes uploading a document or data for review, and submitting the bid by clicking the Place Bid button. Once a person submits their bid, they receive an email confirmation that their bid and document have been successfully submitted. The meeting host receives an email notification that a bid for their meeting has been placed which includes a link to the document or file submitted. The meeting host logs into their on-line account and reviews the information and meeting request, then accepts or declines the meeting bid. Once a meeting is accepted, the meeting host confirms the date and time proposed by email notification with the person who bid; the person who bid receives an email notification from the meeting host stating their meeting bid has been accepted (or declined). If accepted, the person who bid then pays for the meeting.

In a single meeting auction, a meeting host can receive and accept multiple bids and schedule multiple meetings. The highest bidder may not win the meeting, acceptance of bids is based upon the content in the document or data submitted being able to satisfy the meeting requirements or criteria. If there is more than one bid accepted in a single meeting auction, the meeting times are scheduled at different times and, in all cases, dates and times are agreed upon by both parties.

### SUMMARY OF THE INVENTION

The invention provides a method of bidding to qualify and win meeting time when bidding on a person's meeting in an on-line auction. This method includes submitting a document or data such as a meeting agenda or proposal when bidding. The person who has their meeting for auction (meeting host) accepts or declines bids based on the information stated in the document or data that was submitted on-line. A project, requirement, initiative or reason is required for hosting a meeting. The method also includes not accepting meeting bids based on the highest bid amount and accepting multiple bids and scheduling multiple meetings for a single meeting auction.

In an on-line meeting auction, an agenda or proposal provides a meeting host information as to how the bidder will potentially fulfill their needs and reasons for hosting a meeting. Once a meeting is submitted for auction by a meeting host, it is advertised on-line to the public and includes the meeting criteria or requirements. This method also protects the bidder from bidding on a meeting that may not be of value to them. Bids placed include a document or data, such as an agenda or proposal. The meeting host accepts or declines meeting bids based on the content submitted in the document at time of bidding.

### BRIEF DESCRIPTION OF DRAWINGS

The accompanying drawings, which are incorporated herein, illustrate the presently preferred embodiments of the invention and, together with the general description given above and the detailed description given below, serve to explain the features of the invention.

FIG. 1A is a screenshot of information on-line about the meeting auction process, in accordance with an embodiment of the invention;

FIG. 1B is a screenshot of the on-line meeting auction, in accordance with an embodiment of the invention;

FIG. 2A is a screenshot of a place bid form with meeting agenda or proposal document upload requirement and meeting criteria, part of the method of the invention in accordance with an embodiment of the invention;

FIG. 2B is a drawing of the bidding process, in accordance with an embodiment of the invention;

FIG. 2C is a screenshot of the message for requirement to upload a document before proceeding with placing a bid, in accordance with an embodiment of the invention;

FIG. 3A is an illustration of an example of an embodiment of the method of invention;

FIG. 3B is an illustration of an example of an embodiment of the method of invention;

FIG. 4 is a screenshot of email communication informing meeting host of a new bid with link to view agenda document, in accordance with an embodiment of the invention;

FIG. 5A is a screenshot of an on-line form for registering as a meeting host, in accordance with an embodiment of the invention;

FIG. 5B is a screenshot of the meeting host control panel and account dashboard where meetings are added, edited, deleted and viewed, in accordance with an embodiment of the invention;

FIG. 5C is a screenshot of the meeting host account dashboard where meetings are accepted, denied, scheduled and where information submitted is viewed, in accordance with an embodiment of the invention;

FIG. 5D is a screenshot of an on-line form for adding a meeting auction with requirements, in accordance with an embodiment of the invention;

FIG. 6 is a meeting disclaimer, in accordance with an embodiment of the invention;

FIG. 7A is an illustration of Frequently Asked Questions, page 1 of 2, in accordance with an embodiment of the invention;

FIG. 7B is an illustration of Frequently Asked Questions, page 2 of 2, in accordance with an embodiment of the invention;

FIG. 8 is an illustration of a meeting auction flow chart, in accordance with an embodiment of the invention;

### DETAILED DESCRIPTION OF THE PREFERRED EMBODIMENTS

Reference will now be made in detail to the preferred embodiments of the present invention, examples of which are illustrated in the accompanying specifications. It is to be understood that the Figures and descriptions of the present invention included herein illustrate and describe elements that are of particular relevance to the present invention, while eliminating, for purposes of clarity, other elements found in typical on-line meeting auctions.

The invention provides a method of bidding to qualify meetings when bidding on a person's meeting in an on-line auction. The invention is designed to qualify bidders for meetings in an on-line meeting auction. The method is particularly applicable to on-line meeting auctions where people bids on business meetings for business purposes.

The process for bidding on a meeting in an on-line meeting auction is described below.

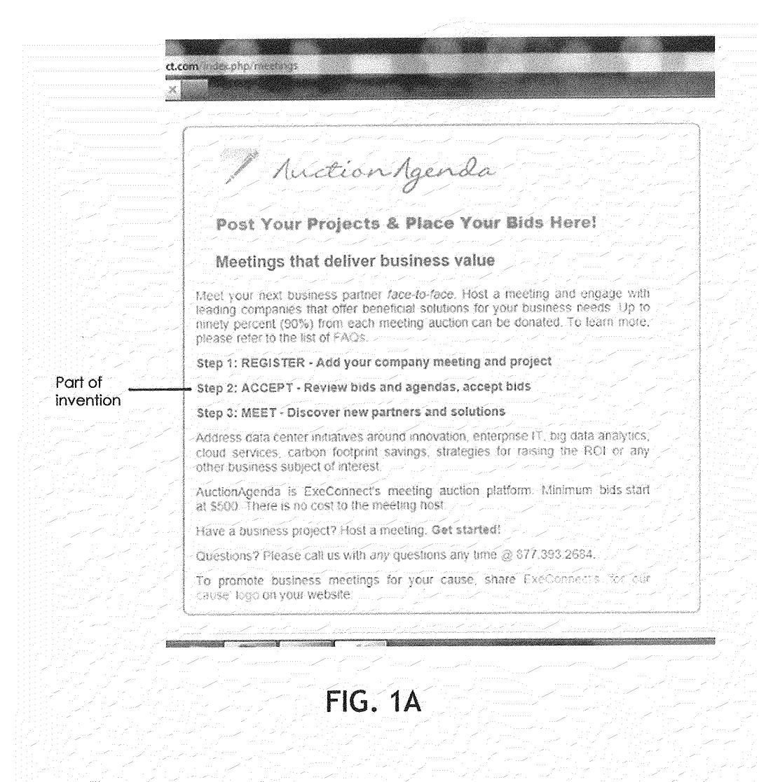

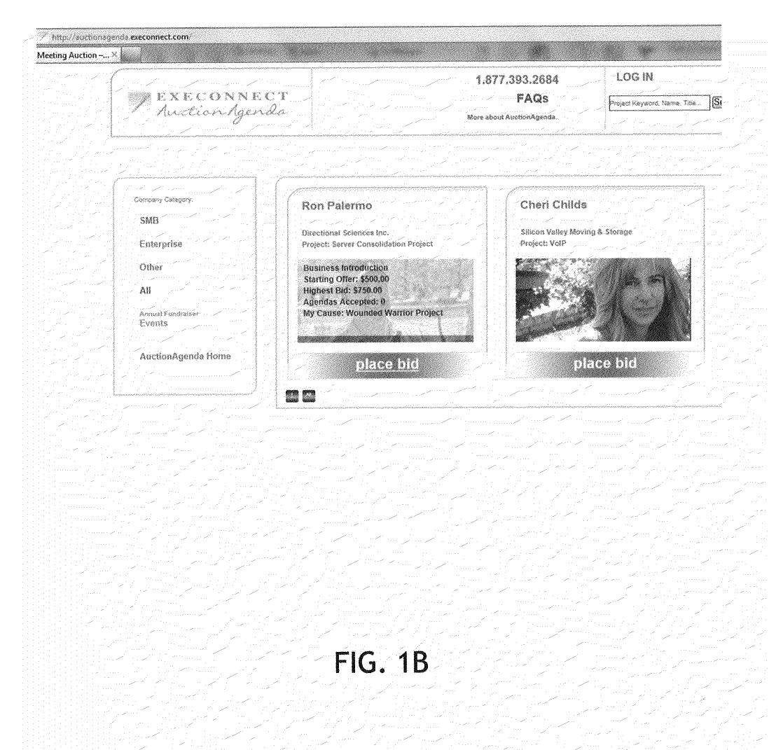

The process for hosting a meeting is described with reference to FIG. 1A. FIG. 1A illustrates information about the meeting auction process for a meeting host, particularly Step 2 where the meeting host accepts bids and meetings after reviewing agendas submitted.

The beginning process for bidding on a meeting is described with reference to FIG. 1B. FIG. 1B illustrates a person's meeting posted for auction on-line.

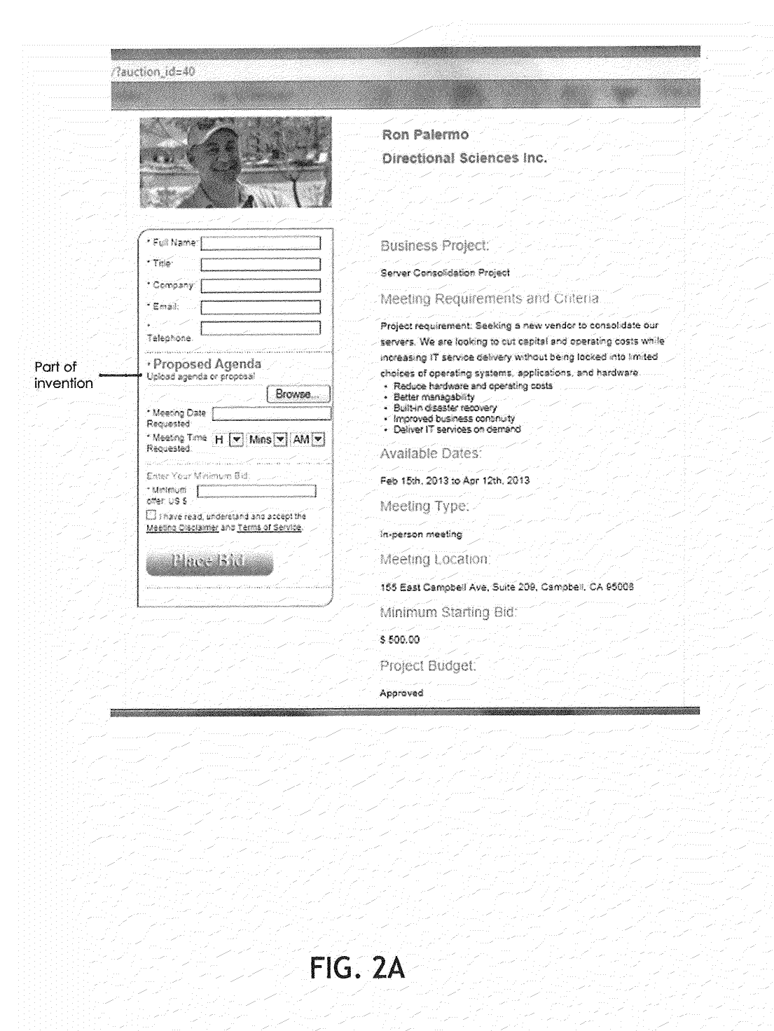

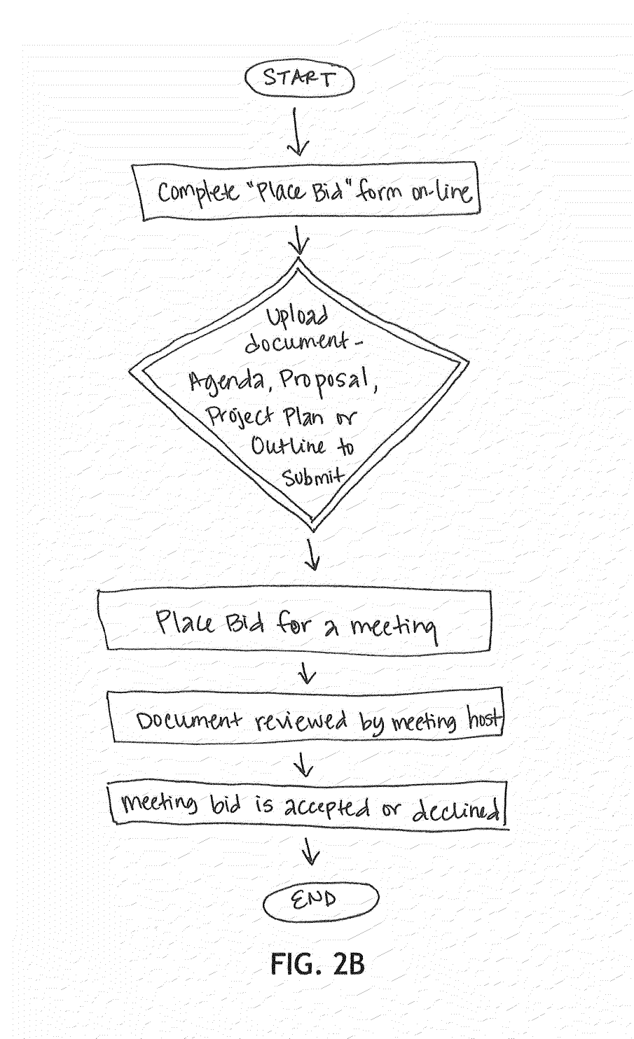

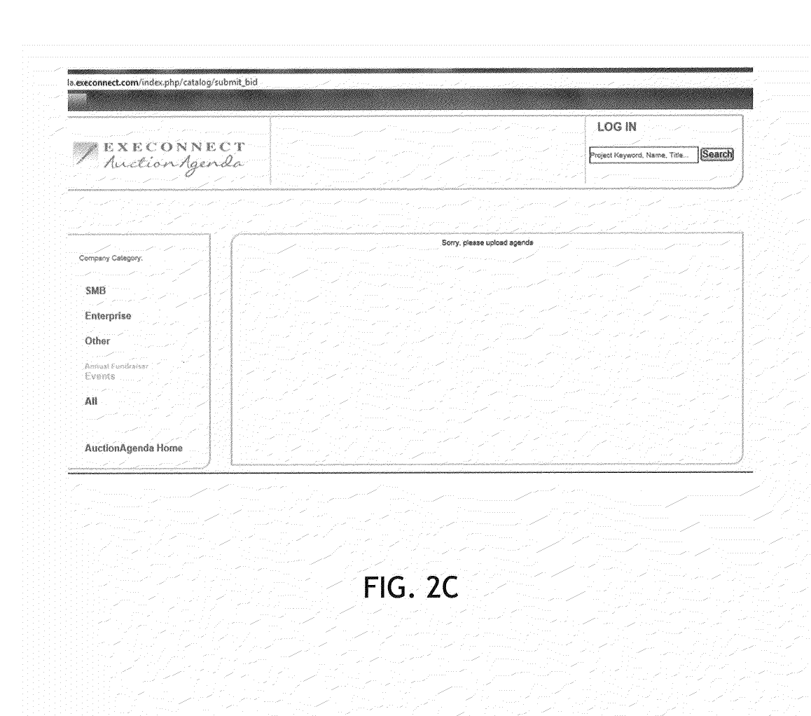

FIG. 2A illustrates how to place a bid in a meeting auction, showing an on-line submission form for bidding on a meeting; the form shows who the meeting is with, a title and company name, meeting requirements and criteria, and particularly where to upload required meeting agenda or proposal document; meeting requirements, criteria and availability are listed by the meeting host.

FIG. 2B is a drawing that illustrates the meeting auction bidding process: the bidder completes a Place Bid form on-line which includes uploading and submitting a document (meeting agenda or proposal); the bidder places bid; the document submitted is received and reviewed by the meeting host to determine if they want to accept the meeting bid; the meeting host accepts or declines the bid.

FIG. 2C illustrates a message that is received by the bidder stating that an agenda must be uploaded before move forward with placing a bid.

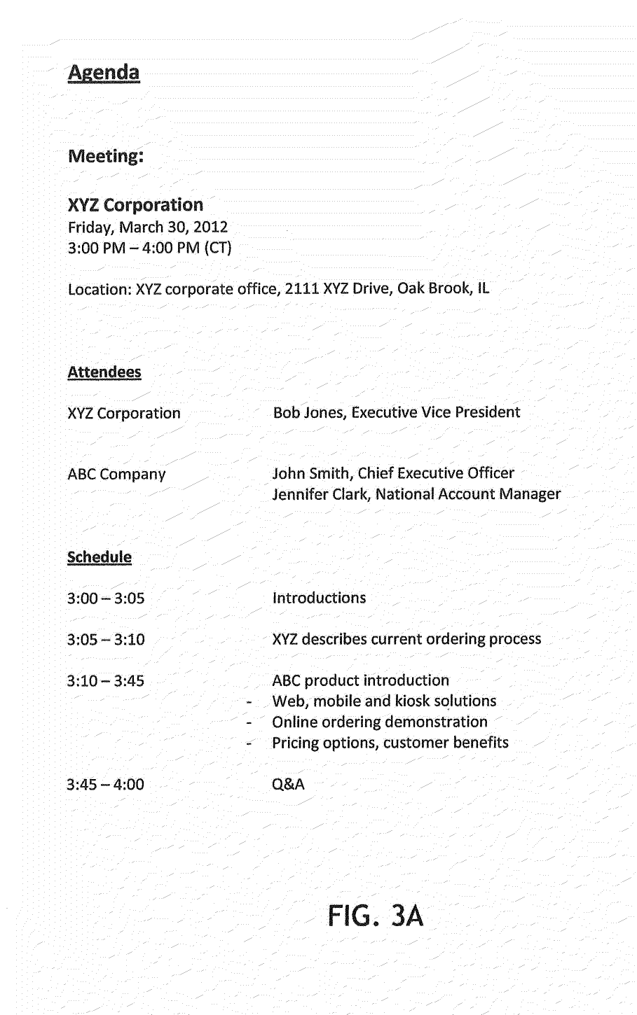

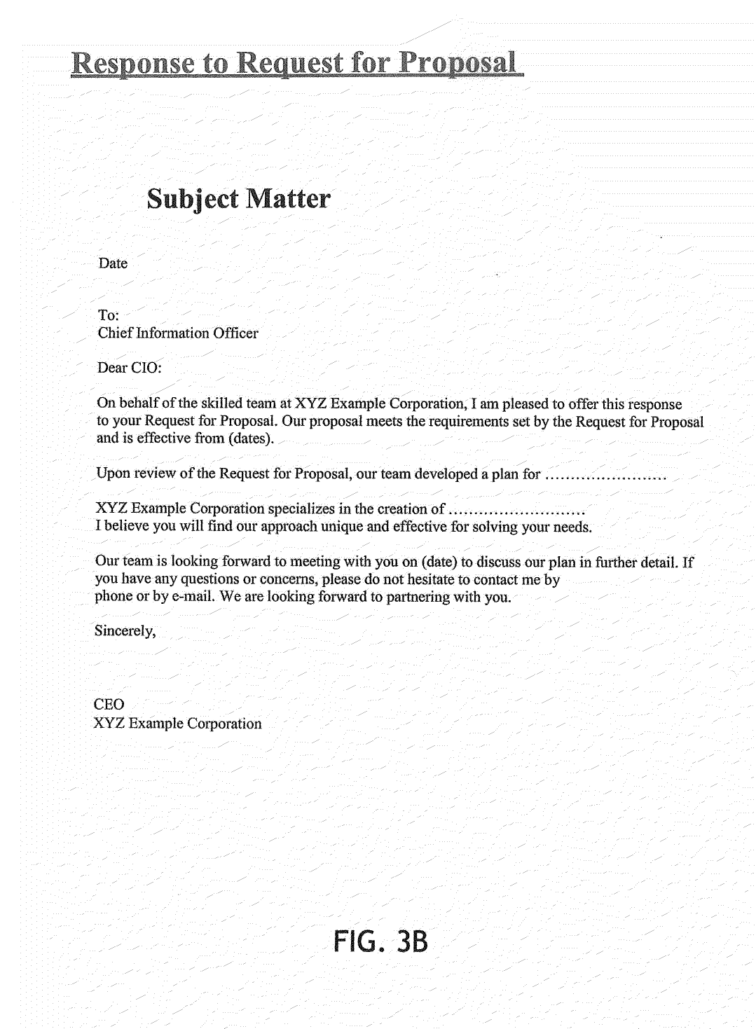

FIG. 3A illustrates an example of a meeting agenda. Shown in FIG. 3B is an example of a proposal.

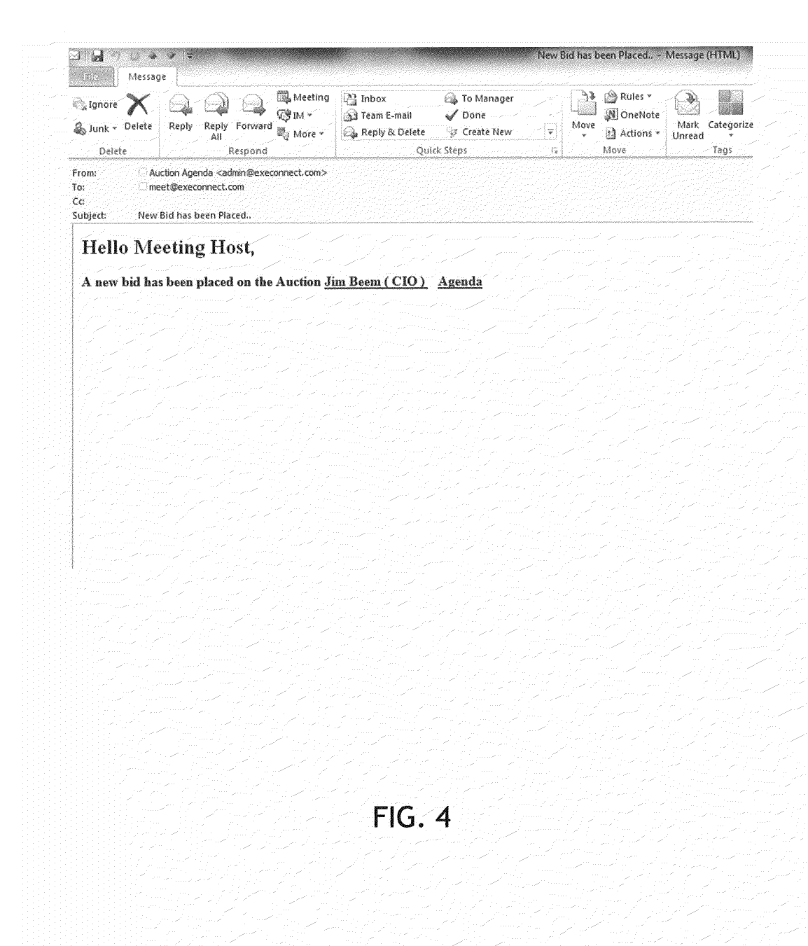

After a bidder has placed a meeting bid online, the meeting host receives notification of the bid with link to the agenda or document submitted. Shown in FIG. 4 is email communication informing the meeting host of a new bid for a meeting with them and a link to view the information about the bidder's agenda or proposal.

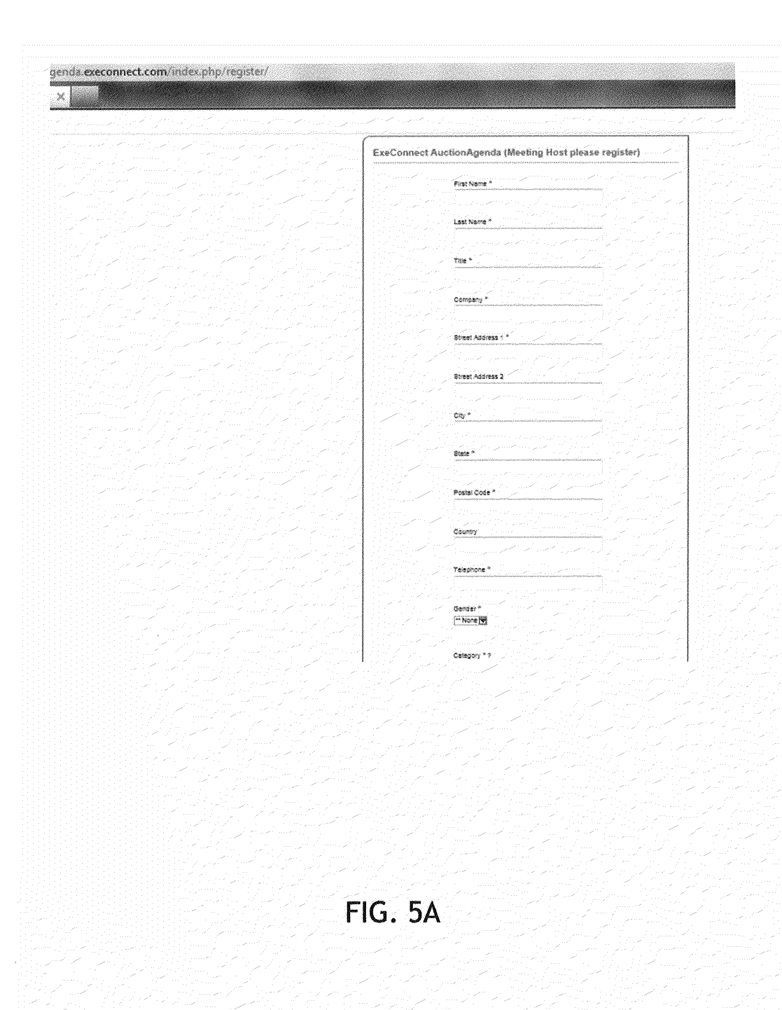

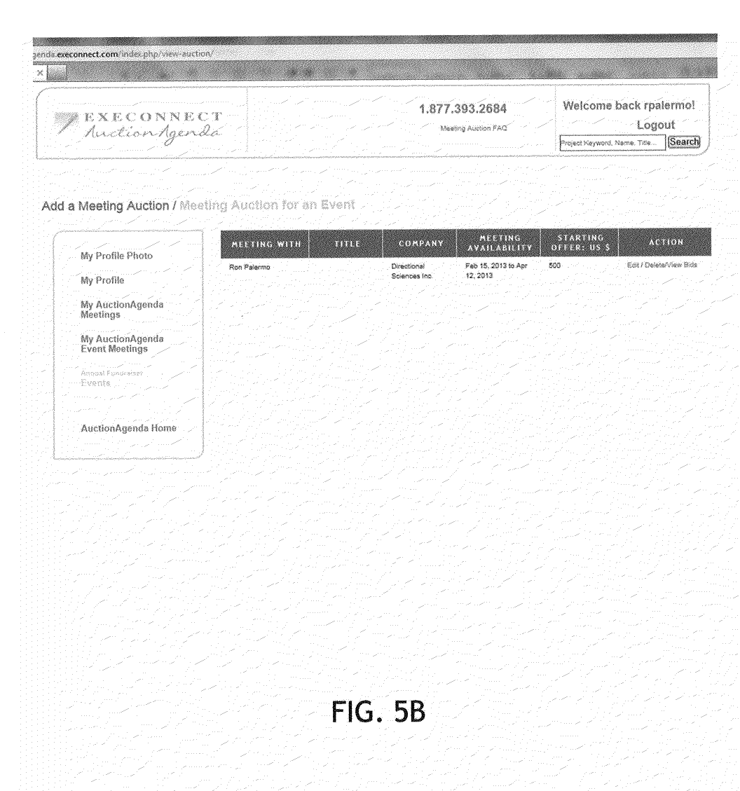

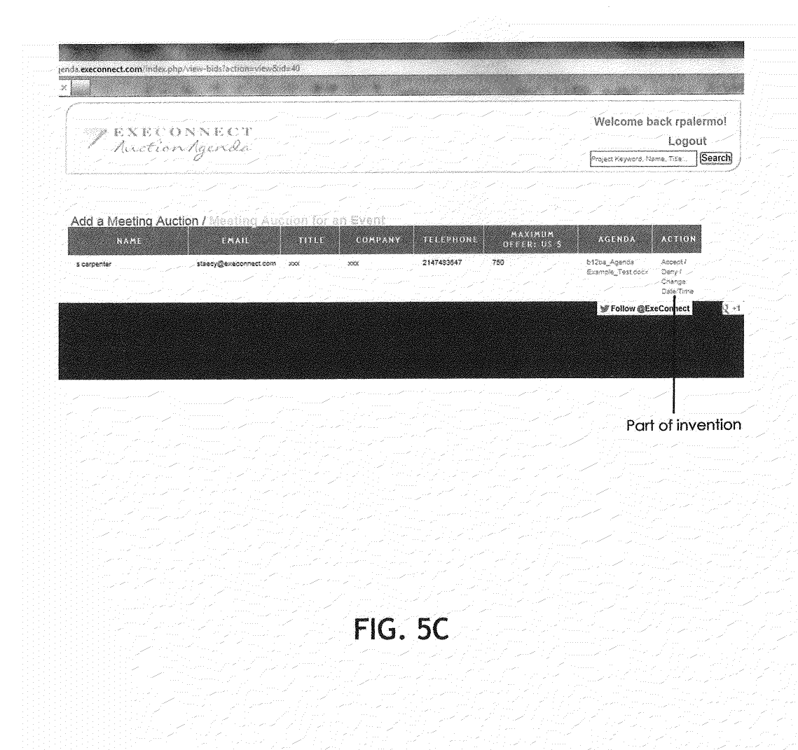

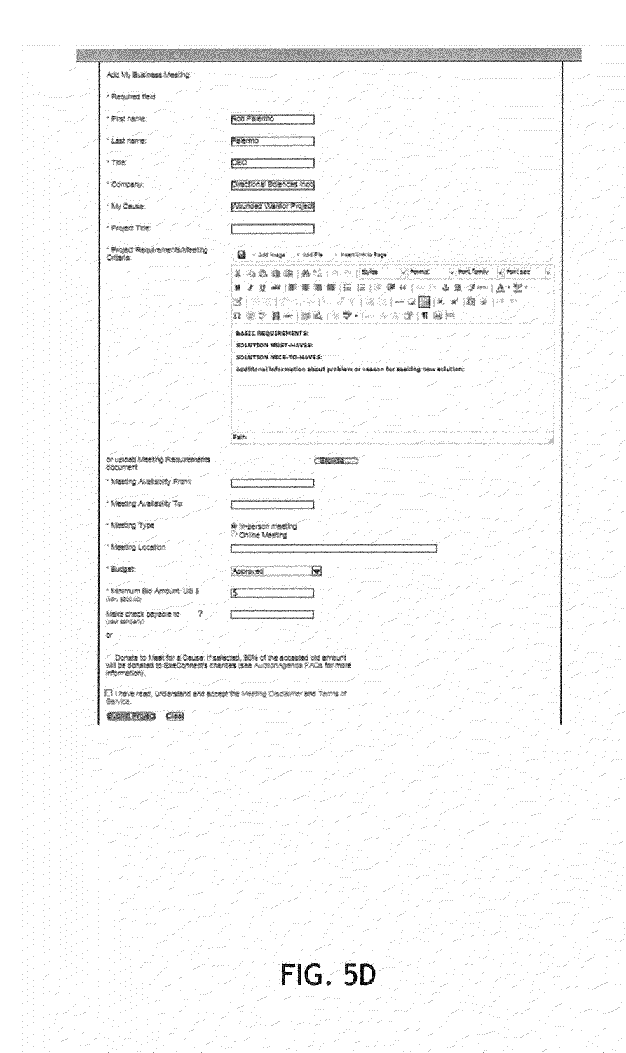

FIG. 5A illustrates an on-line form for meeting host to register a meeting auction. A meeting host completes and submits a form including but not limited to information about a project, requirement or initiative with meeting auction details including name, title, company, meeting availability, starting bid amount, photo, meeting type (in-person or on-line), meeting location, meeting title, meeting requirements and criteria, and budget. FIG. 5B illustrates an account dashboard and control panel for meeting host where meetings are added, edited, deleted and

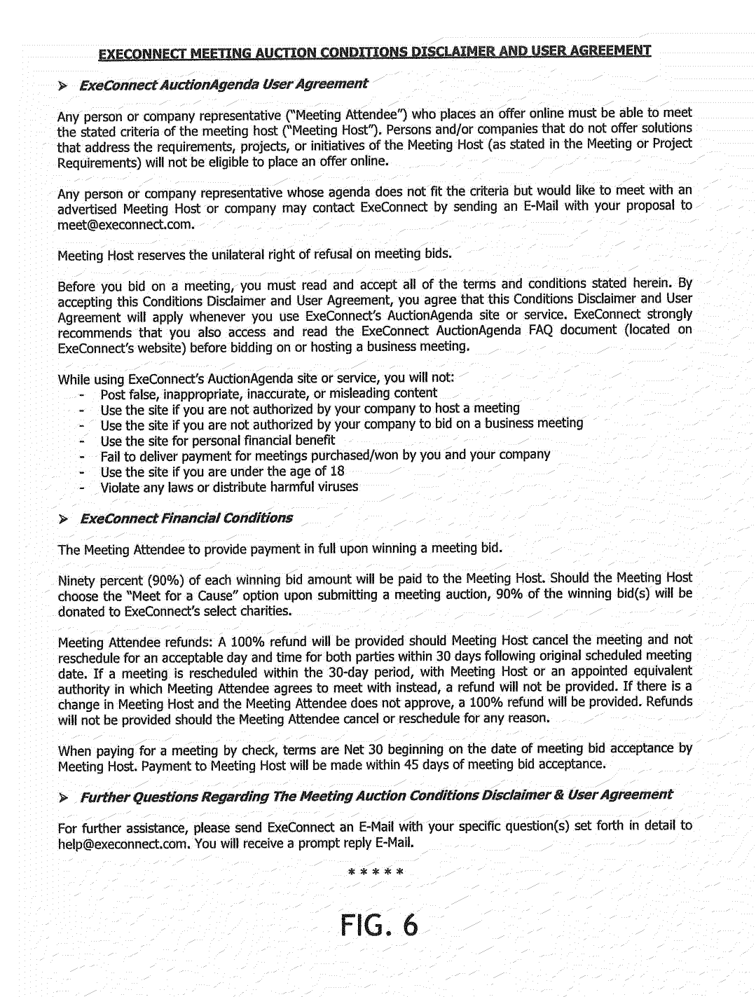

FIG. 6 illustrates meeting auction conditions and a disclaimer which is required to be read and accepted by bidders, it states that any person or company representative (meeting attendee) who places an offer online must be able to satisfy the stated criteria of the meeting host.

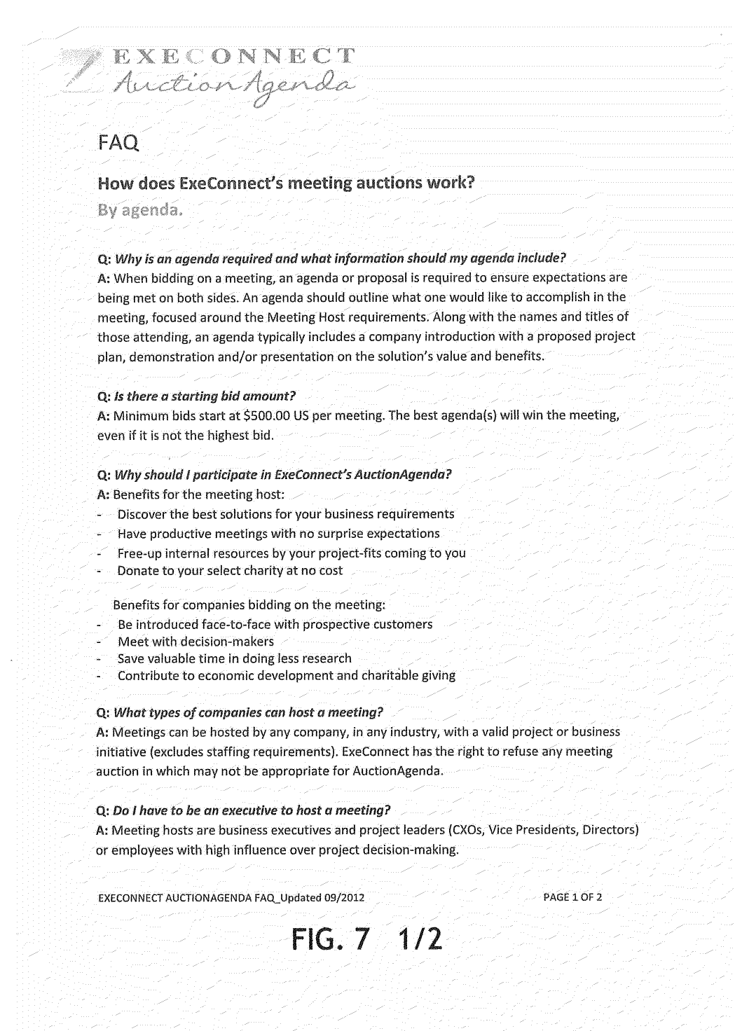

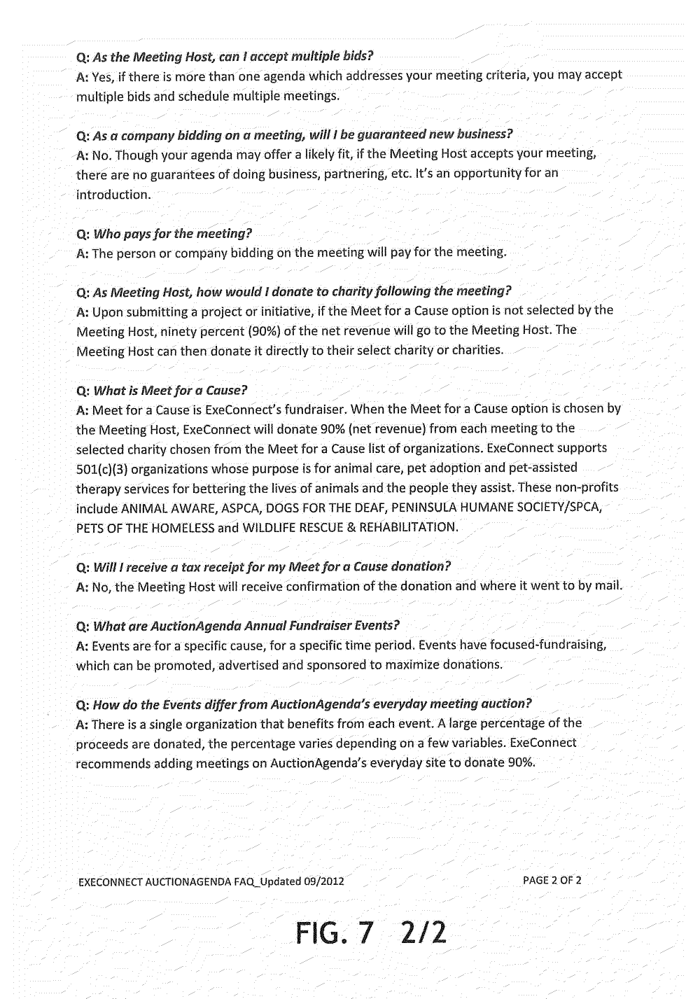

FIG. 7A and FIG. 7B show Frequently Asked Questions with answers about participating in a meeting auction, describing an agenda and meeting auction conditions for hosts and bidders, including the best agendas will win the meeting, even if it is not the highest bid, and multiple bids can be accepted as well as scheduling of multiple meetings.

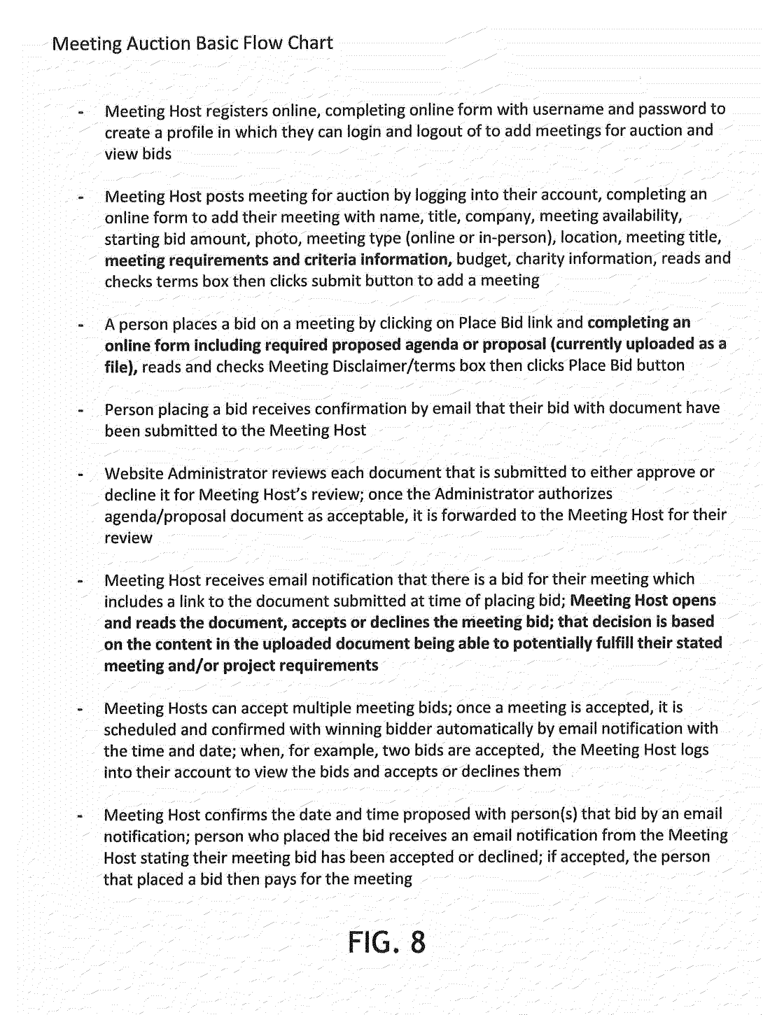

FIG. 8 shows a flow chart of a meeting auction process which describes the meeting auction process.

While the invention has been described in detail and with reference to specific embodiments thereof, it will be apparent to one skilled in the art that various changes and modifications can be made therein without departing from the spirit and scope thereof. Thus, it is intended that the present invention covers the modifications and variations of this invention provided they come within the scope of the appended claims and their equivalents.

What is claimed:

1. A method, comprising: submitting a document (such as a proposed meeting agenda or proposal) or data (such as video communication or video file format) with information in response to the meeting host's stated requirements or criteria and purpose for hosting a meeting (either in-person or on-line) in an on-line meeting auction; bidders are qualified and win meetings based on the information provided in the document or data submitted.

2. The method of claim 1 further comprising accepting or declining meeting bids based on the information submitted for delivering minimum expectations within the stated criteria.

3. The method of claim 1 further comprising not accepting meeting bids based on the highest bid amount.

4. The method of claim 1 further comprising accepting one or multiple bids and scheduling one or multiple meetings in a single meeting auction.
